(19) United States
(12) Patent Application Publication
(10) Pub. No.: US 2026/0319564 A1
(43) Pub. Date: Oct. 15, 2026

(54) SYSTEMS AND METHODS FOR PERFORMANCE THROTTLING OF DATA STORAGE SYSTEMS

(71) Applicant: Microchip Technology Incorporated, Chandler, AZ (US)

(72) Inventors: Nian Niles Yang, Mountain View, CA (US); Pitamber Shukla, San Jose, CA (US); Saswati Das, Milpitas, CA (US)

(73) Assignee: Microchip Technology Incorporated, Chandler, AZ (US)

(21) Appl. No.: 19/322,251

(22) Filed: Sep. 8, 2025

Related U.S. Application Data
(60) Provisional application No. 63/787,055, filed on Apr. 11, 2025.

(51) Int. Cl. G06F 1/324; G06F 3/06; G06F 11/30

(52) U.S. Cl. CPC G06F 1/324; G06F 3/0625; G06F 3/0653; G06F 3/0679; G06F 11/3034

(57) ABSTRACT

A data storage system comprises at least one processor and computer-readable media including a non-volatile memory component. The computer-readable media stores instructions that, when executed by the at least one processor, cause the at least one processor to: monitor operating conditions associated with the data storage system; and throttle performance of the data storage system based at least in part on the monitored operating conditions, the throttling performance including one or more of: adjusting a frequency of a clock signal, relocating critical data within the non-volatile memory component, or adjusting one or more parameters of the non-volatile memory component.

### CROSS-REFERENCE TO RELATED APPLICATIONS

The current patent application claims the benefit under 35 U.S.C. § 119(e) of the priority date of U.S. Provisional Application Ser. No. 63/787,055; titled “SYSTEMS AND METHODS FOR PERFORMANCE THROTTLING WITH SOLID STATE DRIVES”; and filed Apr. 11, 2025. The Provisional Application is hereby incorporated by reference, in its entirety, into the current patent application.

### TECHNICAL FIELD

Various examples of the present disclosure relate to improving data storage system performance.

### BACKGROUND

Data storage devices, such as solid state drives (SSDs), may include non-volatile memory (NVM) media (e.g., NAND-based memory media) for data storage, and typically include application-specific integrated circuitry (ASIC) controllers for managing read, write (or program), erase, and other operations. Data storage devices may be used in enterprise computing data center solutions (DCS) and certain high-performance computing (HPC) applications, such as artificial intelligence (AI). It is generally desirable to improve performance and/or reduce the cost of data storage devices, but it may be difficult to do so.

This background discussion is intended to provide information related to the present invention which is not necessarily prior art.

### SUMMARY OF THE INVENTION

According to various examples of the present disclosure, a data storage system comprises at least one processor and computer-readable media including a non-volatile memory component. The computer-readable media stores instructions that, when executed by the at least one processor, cause the at least one processor to: monitor operating conditions associated with the data storage system; and throttle performance of the data storage system based at least in part on the monitored operating conditions, the throttling performance including one or more of: adjusting a frequency of a clock signal, relocating critical data within the non-volatile memory component, or adjusting one or more parameters of the non-volatile memory component.

According to various examples of the present disclosure, a data storage system comprises a clock generator configured to generate a clock signal at a first frequency, at least one processor and computer-readable media including a non-volatile memory component. The computer-readable media stores instructions that, when executed by the at least one processor, cause the at least one processor to: determine a process corner associated with the non-volatile memory component; and configure, based in part on the process corner, the clock generator to generate the clock signal at a second frequency. The second frequency is greater than the first frequency.

According to various examples of the present disclosure, a data storage system comprises a clock generator configured to generate a clock signal at a first frequency, at least one processor and computer-readable media including a non-volatile memory component. The computer-readable media stores instructions that, when executed by the at least one processor, cause the at least one processor to: receive, from a host system, an indication to reduce power consumption; and configure, based at least in part on the indication, the clock generator to generate the clock signal at a second frequency. The second frequency is lower than the first frequency.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1A illustrates an example performance throttling system including a host system and a plurality of data storage systems;

FIG. 1B illustrates various components of the host system and one or more of the data storage systems of FIG. 1A;

FIG. 2 illustrates an example computing system configured to perform operations in accordance with the various examples of the present disclosure;

FIG. 3 illustrates an example non-volatile memory (NVM) media in accordance with the various examples of the present disclosure;

FIG. 4 illustrates an example physical block of a data storage component in accordance with the various examples of the present disclosure;

FIG. 5A illustrates an example graph of performance of a data storage system correlated with a number of program/erase cycles;

FIG. 5B illustrates an example graph of performance of a data storage system correlated with a bit error rate;

FIG. 5C illustrates an example graph of performance of a data storage system correlated with data retention duration;

FIG. 5D illustrates an example graph of performance of a data storage system correlated with process corners;

FIG. 5E illustrates an example graph of performance of a data storage system correlated with cross temperature;

FIG. 5F illustrates an example graph of performance of a data storage system correlated with a NAND interface speed;

FIG. 5G illustrates an example graph of performance of a data storage system correlated with power utilization;

FIG. 6 illustrates an example method for throttling performance of a data storage system based on operating conditions;

FIG. 7 illustrates an example method for throttling performance of a data storage system based on process corners;

FIG. 8 illustrates an example method for throttling performance of a data storage system based on power requirements; and

FIG. 9 illustrates an example method for throttling performance of a data storage system.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

The term “signal” or “electronic signal” may be used to describe electrical energy con-ducted through an electrically conductive medium in which an electric voltage and/or an electric current varies, or may be constant, over time. An electronic signal may be an electromagnetic wave, voltage, and/or current, and may be encoded with or representative of information.

The term “electrically connected” may refer to components comprising conductor(s) such as terminals or contacts, with the conductor(s) of the respective electrically connected components being in electrical communication with one another via a pathway, the pathway typically comprising one or more conductor(s) such as metal(s) or metal alloy(s), optionally being interspersed with electronic component(s), and allowing the electrical communication via flow of electric current therebetween.

The phrase “responsive to” or “in response to” may refer to an operation performed directly in response to the occurrence of, or based in part on, a preceding operation and/or condition.

Various examples of the present disclosure may be used in single-level cell (SLC) systems, multi-level cell (MLC) systems, triple-level cell (TLC) systems, quad-level cell (QLC) systems, and penta-level cell (PLC) systems, without limitation. Applications may include consumer hard drives, high performance computing (HPC), data transfer for AI, and data center solutions (DCS), without limitation.

In various examples of the present disclosure, a data storage system may include a data storage component and a controller. The data storage system may be connected to a host system. The controller may be operable to manage storage and retrieval of data between the data storage component and the host system. The data storage system may be configured for performance throttling. Performance throttling may include increasing or decreasing an operating speed of the data storage system. For example, a clock speed for one or more internal components of the data storage system may be increased when faster performance is desired. The clock speed for the one or more component(s) may be decreased when it is desirable to reduce power consumption, prioritize error rate over speed, or achieve other objectives.

Increasing the operating speed may reduce latency when retrieving critical data while preserving data reliability and optimize data storage system performance by dynamically increasing operating speeds when conditions are favorable for increased operating speeds. Additionally, decreasing the operating speed may reduce error rates associated with read/write operations, reduce power consumption, and extend a life cycle of the data storage system by slowing down operating speeds when the data storage system would otherwise be retired (e.g., by producing too many errors at a default operating speed).

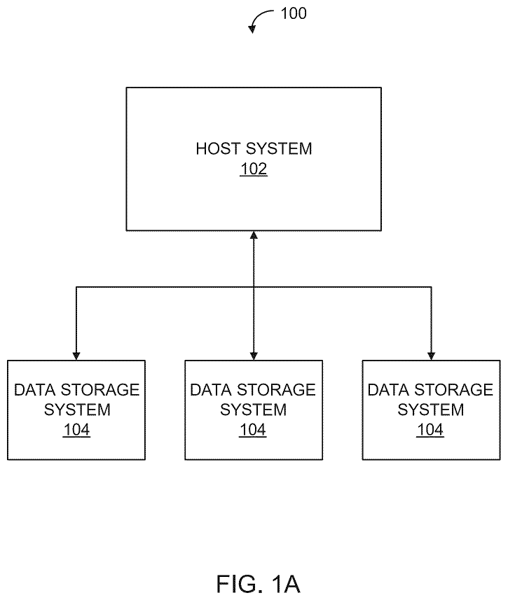

FIG. 1A illustrates an example system 100 including a host system 102 and a plurality of data storage systems 104. The host system 102 may manage storage and retrieval of data to and from each of the data storage systems 104. Although three (3) data storage systems 104 are shown, it would be appreciated by one of ordinary skill in the art that the host system 102 may be connected to many more, or fewer, data storage systems 104. For example, the host system 102 may be connected to as many as twenty four (24) or more data storage systems 104. Specific operations and components of the host system 102 and the data storage systems 104 are described below in connection with FIG. 1B.

Referring to FIG. 1B, the host system 102 includes at least one processor 103 and a local memory 105. A single data storage system 104 is shown in FIG. 1B for simplicity. The data storage system 104 includes a controller 106, a plurality of flash channels 111, and a data storage component 114. The controller 106 includes a host interface 107, at least one processor 108, a NAND interface 109, a local memory 110, a performance throttling component 112, and one or more clock generators 113. The data storage component 114 includes a plurality of non-volatile memory (NVM) 116 and one or more local controller(s) 118. In various examples, the performance throttling component 112, the local controller(s) 118, and/or other components of the data storage system 104 and/or host system 102 may include one or more temperature sensors (not shown) to measure operating temperatures of the data storage system 104.

In various examples, a read or write request may be received from the host system 102 via the host interface 107. The host interface 107 may be a peripheral component interconnect express (PCIe) interface that connects the data storage system 104 to servers or CPUs. PCIe is a standardized interface for motherboard components. In various examples, the data storage system 104 may be connected to the host system 102 by wired or wireless means (e.g., through a communications network). The data storage system 104 may be connected to more than one host system, such as in a multi-tenant environment, without limitation. Similarly, the host system 102 may be connected to more than one data storage system, without limitation.

The controller 106 may use logical block addresses (LBAs) and physical block addresses (PBAs) to facilitate access for data storage in and retrieval from the NVM 116. LBAs are an abstraction to allow the operating system to interact with the NVM 116, and PBAs represent the actual hardware locations within the NVM 116. To facilitate interacting with the NVM 116, the controller 106 may create an entry or record that assigns an LBA to a PBA. To keep track of all such LBA-to-PBA assignments, the controller 106 may use an L2P mapping table. When a data request is received from the host system 102, the controller 106 references the L2P mapping table to determine the PBA within the NVM 116 corresponding to a desired LBA. Once the PBA is determined, the controller 106 accesses the appropriate NVM 116 through the NAND interface 109 and one or more of the flash channels 111 to write or read the data. The controller 106 may employ an error correction code (ECC) operation during encoding and decoding data to detect and correct errors and enhance data integrity.

In various examples, the controller 106 and/or the data storage component 114 may support a direct memory access (DMA) operation enabling data to be written from the host system 102 directly to the NVM 116 and read from the NVM 116 directly to the host system 102. Certain commands may be issued to the controller 106 or the local controller(s) 118 using the host command layer, or non-volatile memory express management interface (NVMe-MI).

In various examples, the data storage system 104 may be a solid state drive (SSD), and the NVM 116 may be NAND-based flash memory. It would be appreciated by one of ordinary skill in the art that other memory devices (e.g., NOR flash memory, random access memory, and the like) may be utilized in the various examples described herein without departing from the spirit of the present disclosure.

In various examples, the controller 106 may receive a write request from the host system 102. The write request may include user data for one or more data operations to be written to one or more of the NVM 116 of the data storage component 114. The user data may include, for example, media (e.g., photos, videos, and/or audio), system information data, application data, sensor data, document data, recordkeeping data, machine learning/artificial intelligence data, training data, inference data, gaming system data, data pertaining to internal operations of the host system, and the like, without limitation.

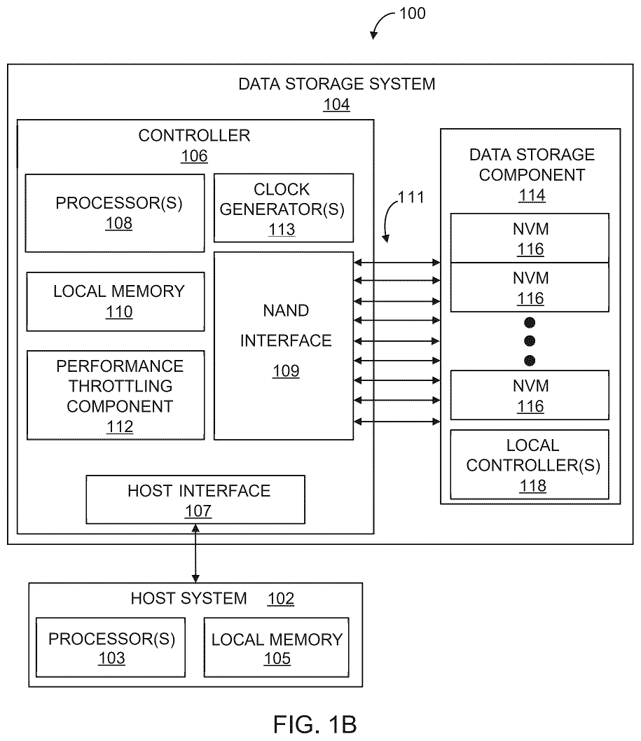

FIG. 2 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIGS. 1A and 1B), a data storage system (e.g., the data storage system 104 of FIGS. 1A and 1B), and/or another computing device configured to perform some and/or all operations of the various examples of the present disclosure, without limitation.

The software program 210 may be configured with instructions for performing and/or enabling performance of at least some of the steps set forth herein. In an example, the software program 210 comprises instructions stored on computer-readable media of memory element 206. In various examples, the software program 210 may include instructions for performing operations of the performance throttling component 112 discussed with reference to FIG. 1B.

The communication network 212 generally allows communication between the computing system 200 and another computing device, such as between a remote host system, a local host system (e.g., the host system 102 of FIGS. 1A and 1B), and/or a data storage system (e.g., the data storage systems of FIGS. 1A and 1B), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are com-patible with networking technologies such as ethernet. In certain examples, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some examples, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In various examples, the memory element 206 stores the software applications/program 210. The memory element 206 may also store settings, data, documents, sound files, photo-graphs, movies, images, databases, and the like. In various examples, the memory element 206 may include a first memory component (e.g., the local memory 105 and/or the local memory 110 of FIG. 1B) and one or more SSDs (e.g., the data storage component 114 of FIG. 1B).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

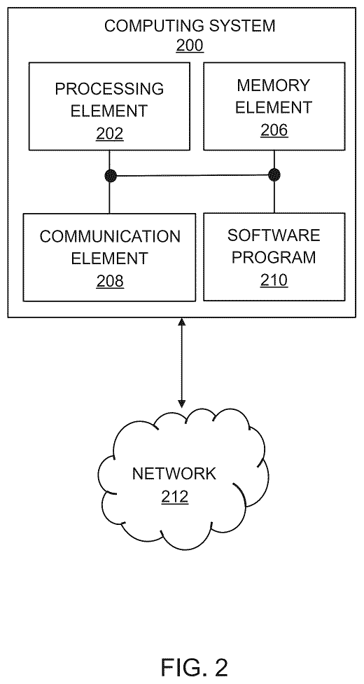

Turning to FIG. 3, the NVM 116 may respectively include a plurality of LUNs. As illustrated, the NVM 116 includes LUNs 120a, . . . 120n, where ‘a’ and ‘n’ are integers. As such, each NVM 116 may include, for example, two (2), four (4), six (6), eight (8), or more LUNs, without limitation. Each LUN 120a, . . . 120n may include a plurality of planes 304a, . . . 304n, again where ‘a’ and ‘n’ are integers. Each LUN 120a, . . . 120n may include, for example, four (4), six (6), eight (8), or more planes, without limitation.

Each plane may include a cache register 306, a page register 308, and a plurality of physical memory blocks 310. In various examples, the controller 106 may write incoming data to more than one NVM 116 in parallel. The NVM 116 may write incoming data to more than one LUN in parallel.

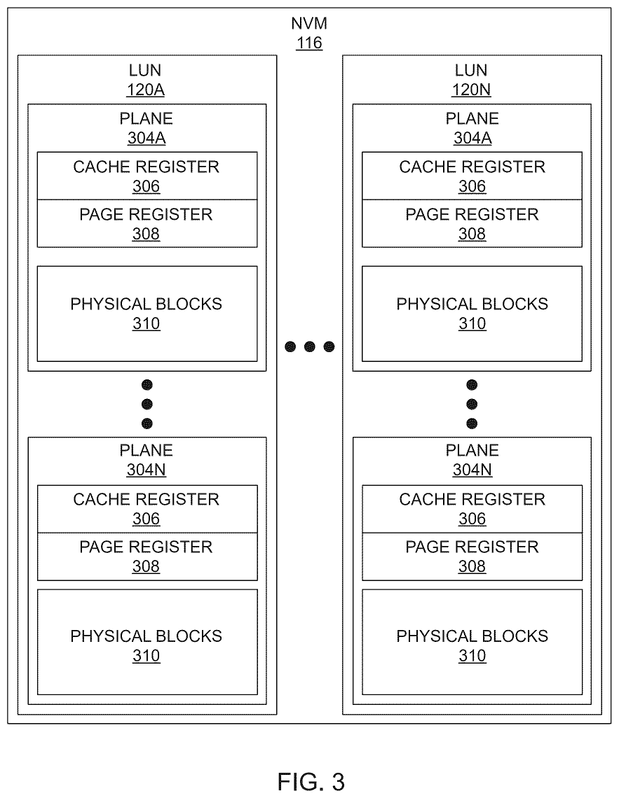

When data is written to or retrieved from the NVM 116, the data may be temporarily stored in one of the cache register 306 and/or the page register 308. Each physical memory block 310 may include a set of pages (as described in connection with FIG. 4 below). The cache register 306 and the page register 308 may respectively have an equivalent data capacity of one page. Accordingly, data to be written to a first page may be temporarily stored in the cache register 306 while data to be written to another page may be temporarily stored in the page register 308. Data to be read from a first page may be retrieved and temporarily stored in the cache register 306 while data to be read from another page may be stored in the page register 308. Accordingly, the cache register 306 and page register 308 enable double buffering of data to reduce data programming and read times.

Turning to FIG. 4, each of the physical memory blocks 310 includes a plurality of wordlines (WLs) 402a, 402b, 402c . . . 402n, a plurality of bit lines (BLs) 404a, 404b, 404c, 404d, . . . 404n, and a plurality of cells 406. In various examples, a page may be defined as a row of cells connected to the same WL (e.g., the cells 406 connected to the WL 402a are collectively referred to as a page). Each page may include a plurality of cells 406. Each cell 406 may include a transistor having a gate, a source, and a drain. Data bits may be written to the cells 406 on a page-by-page basis. Data may be erased from the plurality of cells 406 on a physical memory block basis.

Generally, each WL is an electrical conductor that is electrically connected to control gates of the cells in a respective row of cells. Each WL may convey an electronic signal that, according to its voltage level, selects a row (or page) of cells. (Each WL 402a, 402b, 402c, . . . 402n may be drawn as a horizontal line shown in FIG. 4.) When a specific WL is activated (e.g., when a read voltage is applied), the cells connected to that WL are selected for reading or writing. In NAND flash memory, cells are organized into a series of strings, with each string being connected to one of a plurality of BLs, wherein each BL is an electrical conductor that is electrically connected to the drains of cells in a column of cells. Each BL may convey an electronic signal that, according to its voltage level, may enable data transfer to and from the cells of a selected WL during read and write operations. (Each BL 404a, 404b, 404c, 404d . . . 404n may be drawn as a vertical line shown in FIG. 4.) During a read operation, the voltage on the BL reflects a state of the selected cell(s). Accordingly, the voltage and/or current of the BL may be measured and/or determined to determine the value of the data in the selected cells.

In various examples, the cells 406 may include single-level cells (SLCs), multi-level cells (MLCs), triple-level cells (TLCs), quadruple-level cells (QLCs), and/or penta-level cells (PLCs), without limitation. Accordingly, the WLs 402a, 402b, 402c . . . 402n may be SLC word-lines, MLC wordlines, QLC wordlines and/or PLC wordlines, without limitation. In an example, a TLC wordline may include a lower page, a middle page, and an upper page. The lower page, middle page, and upper page may correspond to a page including a row of TLCs. The TLC wordline may be activated to write data to each of the upper, middle, and lower pages. Accordingly, an SLC wordline may include one (1) page, an MLC wordline may include two pages (2), a TLC wordline may include three (3) pages, a QLC wordline may include four (4) pages, and a PLC wordline may include five (5) pages.

String select line 408 is an electrical conductor that is electrically connected to gates of string select transistors 410. The string select line 408 may convey an electronic signal that, according to its voltage level, selects one or more of the string select transistors 410. A BL bias voltage may be supplied to one or more of the BLs 404a, 404b, 404c, 404d, . . . 404n via the string select line 408. Similarly, ground select line 412 is an electrical conductor that is electrically connected to gates of ground select transistors 414. The ground select line 412 may convey an electronic signal that, according to its voltage level, selects one or more of the ground select transistors 414. The string select transistors 410, when activated (e.g., by receiving a BL bias voltage), may connect a string (or column) of cells 406 to a corresponding one of the BLs 404a, 404b, 404c, 404d, . . . 404n. The ground select transistors 414, when activated, may connect a string (or column) of cells 406 to source line 416. The source line 416 is an electrical conductor that is electrically connected to sources of the cells 406. The source line 416, in turn, may connect the string of cells to a common ground (or reference) voltage. The source line 416 may be connected to a sense amplifier (not shown), which may measure a string current (Icell) and/or voltage of the activated cells 406, thereby determining a value of the data stored in the activated cells 406.

Generally, a read voltage threshold may correspond to a reference voltage used when reading data from a cell. During a read operation, a read voltage may be applied to a WL corresponding to a page, or row of cells. In response to applying the read voltage, each cell may produce a current having a voltage value corresponding to a voltage threshold of that cell. The voltage threshold of the cells may be compared to the reference voltage to determine the value of the data in the cells. In the case of a triple-level cell (TLC), seven (7) different reference voltages are needed to read the three (3) bits stored in the TLC. Specifically, two (2) reference voltages may be used to read a first bit from the TLC, three (3) reference voltages may be used to read a second bit from the TLC, and two (2) reference voltages may be used to read a third bit from the TLC.

In various examples, each NVM 116 may include any combination of SLC blocks, MLC blocks, TLC blocks, QLC blocks, and/or PLC blocks. SLC blocks enable faster read/write operations than higher level cell blocks (e.g., TLC blocks) because data can be read from an SLC with a single read operation, as opposed to seven (7) read operations required to read TLCs, for example.

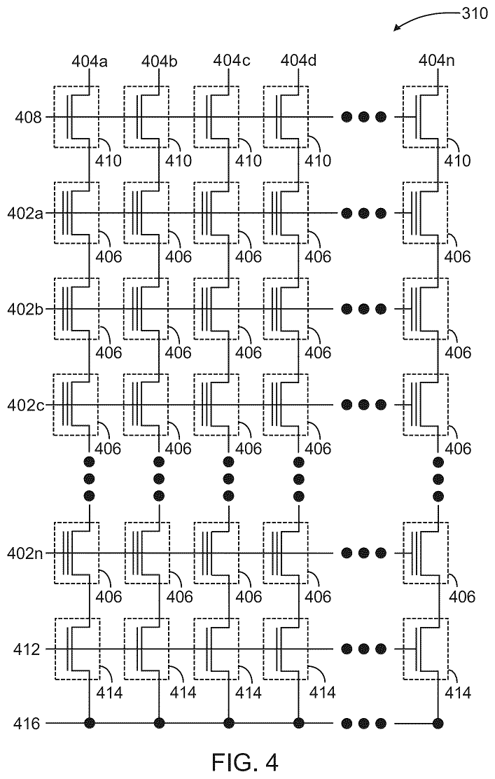

FIGS. 5A-5G illustrate respective graphs of data storage system performance correlated with corresponding parameters and/or conditions of a data storage system (e.g., the data storage systems 104 of FIGS. 1A and 1B). In various examples, performance may refer to a latency associated with reading data from one or more data storage components (e.g., the NVM 116 of FIG. 1B) and transmitting the data to a host system (e.g., the host system 102 of FIGS. 1A and 1B), latency associated with writing data received from the host system to the data storage component(s), data reliability, and the like.

The various parameters and operating conditions shown in FIGS. 5A-5G may be peri-odically or continuously monitored by the host system and/or the data storage system. The parameters may be utilized to determine performance throttling parameters for the data storage system. For example, some of the data storage component(s) may have more favorable conditions (e.g., less P/E cycles, faster process corners, lower bit error rate) than others of the data storage components. The data storage components having the more favorable conditions may have their performance throttled to increase operation speeds, while the others of the data storage components may not have their performance throttled or may have their operation speed reduced.

FIG. 5A illustrates a graph 502 of data storage system performance correlated with a number of program/erase (P/E) cycles. Each block and/or WL of the data storage component(s) may be associated with a number of P/E cycles. Each time programmed data is erased from a block, the block has completed a P/E cycle. As the number of P/E cycles increases, the performance may decrease.

FIG. 5B illustrates a graph 504 of data storage system performance correlated with a bit error rate (BER). The BER may refer to a frequency in which errors occur when reading or writing data to the data storage component(s). Performance may decrease as the BER increases.

FIG. 5C illustrates a graph 506 of data storage system performance correlated with a data retention duration. The data retention duration may refer to an amount of time in which data has been stored in a data storage component. Over time, electrons may leak out of the cells of the data storage component, thereby reducing the voltage thresholds of the data storage component. Accordingly, performance of the data storage component may decrease as the data retention duration increases.

FIG. 5D illustrates a graph 508 of data storage system performance correlated with process corners. A process corner may refer to a variation of fabrication parameters when manufacturing integrated circuits, such as an NVM (e.g., the NVM 116 of FIG. 1B). Due to varying process corners, some of the NVM may operate faster or slower than others of the NVM under various different operating conditions (e.g., voltage, clock frequency, temperature, and the like). The process corners of NVM may be measured during a testing phase of fabrication. The measurements may identify relative voltage thresholds of the cells of each NVM. Accordingly, each process corner may indicate whether voltage thresholds of the cells of a corresponding NVM are relatively higher or lower than others. Cells having relatively higher voltage thresholds may be associated with an increased switching time and are labeled as “slow” cells. Cells having relatively lower voltage thresholds may be associated with decreased switching times and are labeled as “fast cells.”

In various examples, the process corner may indicate that the data storage system (or individual NVM of a data storage system, or individual blocks of an NVM, and so on) is relatively slow (e.g., compared to other data storage systems (or components thereof). Accordingly, performance may be increased for relatively faster process corners compared to relatively slow process corners.

FIG. 5E illustrates a graph 510 of data storage system performance correlated with cross temperature. Cross temperature may refer to a mismatch between a programming temperature (e.g., an operating temperature when data is programmed to an NVM) and a read temperature (e.g., an operating temperature when data is read from then NVM). Read voltage thresholds of the cells of the data storage components may increase or decrease due to cross temperature, thereby increasing errors. Accordingly, higher cross temperatures may decrease performance.

FIG. 5F illustrates a graph 512 of data storage system performance correlated with a NAND interface speed. The NAND interface speed may refer to a speed at which a NAND interface (e.g., the NAND interface 109 of FIG. 1B and/or an interface between the data storage system 104 and the host system 102 of FIGS. 1A and 1B such as the host interface 107) may transfer data. The NAND interface speed may dictate or primarily govern overall data throughput of the data storage system. Performance may increase as the NAND interface speed increases.

FIG. 5G illustrates a graph 514 of data storage system performance correlated with power utilization. Increased power utilization may enable faster switching times of the data storage system. Performance may increase as power utilization increases.

Returning to FIGS. 1A and 1B, the performance throttling component 112 and/or the host system 102 may monitor various operating conditions of each of the data storage systems 104. The operating conditions may include a number of P/E cycles, a BER, a data retention duration, process corners, cross temperature, interface speed, power utilization, and the like. Some and/or all of the operating conditions may be monitored on a block-by-block basis (e.g., monitoring a respective number of P/E cycles for each block of each NVM 116), on a virtual block by virtual block (VB-by-VB), basis, on a page-by-page basis, and/or on an NVM-by-NVM basis, without limitation.

The monitored operating conditions may be stored as a table in one or more of the NVM 116 and/or the local memory 110 of a corresponding one of the data storage systems 104, and/or the local memory 105. The monitored operating conditions may be updated continuously, in response to a performance throttling request, in response to performing one or more operations (e.g., P/E cycles may updated after each P/E cycle is completed), and/or periodically.

The host system 102 and/or the controller 106 may generate a performance profile for the data storage component 114. Respective performance profiles may be generated for each data storage system 104, for each NVM 116 of each data storage system 104, for groups of NVM 116 for each data storage system, for each block of each NVM 116, and/or for each page of each block of each NVM 116, in any combination.

Each performance profile may include monitored operating conditions of a corresponding one of the data storage systems 104. The operating conditions may include a number of P/E cycles, access latency, BERs, cross temperature conditions, data retention durations, NAND interface speeds, block types (e.g., SLC blocks, TLC blocks, and the like), power consumption, access frequencies for various LBAs, available data capacity, utilized data capacity, a status of data stored in the NVM 116, and the like. The performance profiles may be stored in the local memory 105 of the host system 102 and/or the local memory 110 and/or the NVM 116 of a corresponding one of the data storage systems 104. It is foreseen that the profiles may be stored at or across other computing devices within the scope of the present examples.

In various examples, the performance throttling component 112 may determine that the operating conditions are favorable for increasing operating speeds and automatically issue performance throttling commands to increase the operating speeds. Similarly, the performance throttling component 112 may determine that the operating conditions are unfavorable for increasing operating speeds. Depending on a severity (e.g., whether monitored latency is unacceptable, BER is too high, etc.) of the unfavorable conditions, the performance throttling component may decrease operating speeds or may not perform performance throttling operations. For example, operating speeds may be reduced when the BER meets one or more error criteria (e.g., an increased number of errors at a current operating speed), when the NVM 116 reach a certain P/E cycle count, based on detecting a relatively slow performance corner, and/or other unfavorable conditions identified based on the monitored operating conditions.

The performance throttling component 112 may receive a performance throttling request from the host system 102. The performance throttling request may include a request to in-crease or decrease the operating speed of the data storage system 104. If the performance throttling request includes the request to increase the operating speed, the performance throttling component 112 may increase the operating speed of the data storage system 104. The operating speed of the data storage system may be increased by instructing one or more of the clock generator(s) 113 to increase a clock speed, by relocating critical data to faster data storage components and/or by changing register parameters of the NVM 116 for faster read operations. The performance throttling request may include one or more addresses (e.g., LBAs and/or PBAs) identifying the critical data.

Increasing the clock speed may include increasing a frequency at which one or more clock signals are received by any one or more components of the data storage system 104. For example, the clock signal(s) provided to any one or more of the host interface 107, the processor(s) 108, the NAND interface 109, the local memory 110, and/or the performance throttling component 112, may be generated by the clock generator(s) 113 at an increased frequency, in any combination.

In various examples, the host system 102 and/or the controller 106 may determine a factor by which the clock speed may be increased based on the monitored operating conditions and/or the performance profile. The clock speed may be increased by an amount ranging from five percent (5%) to two hundred percent (200%) depending on the monitored operating conditions, the performance profile, and/or by request from the host system 102. For example, the clock speed of one of the data storage systems 104 may be increased by up to two hundred percent (200%) if the NVM 116 are held at a stable temperature, have undergone a relatively low number (e.g., less than two thousand (2000)) P/E cycles, produce relatively few errors (e.g., compared to others of the data storage systems 104), and have a relatively fast process corner (e.g., compared to others of the data storage systems 104).

In various examples, if one of the data storage systems 104 has a relatively fast process corner (e.g., compared to remaining ones of the data storage systems 104), the frequency of the clock signal(s) may be increased by about five percent (5%), about ten percent (10%) or more.

In various examples, the performance throttling component 112 may dynamically adjust the clock speed for different operations and/or when accessing different ones of the NVM 116. For example, the frequency of the clock signal(s) may be increased when data is read from an SLC block. When data is read from a higher level cell (e.g., TLC) block the frequency of the clock signal(s) may remain unchanged and/or may be decreased (e.g., compared to the frequency of the clock signal(s) when reading from an SLC block).

In various examples, the performance throttling component 112 may dynamically in-crease or decrease the clock speed based on conditions of the NVM 116 undergoing read or write operations. For example, a first of the NVM 116 may produce fewer errors than a second of the NVM 116. The performance throttling component 112 may increase clock speeds when reading data from/writing data to the first of the NVM 116 and decrease clock speeds when reading data from/writing data to the second of the NVM 116. Other operating conditions (e.g., P/E cycles, data retention time, cross temperature, and the like) may be included in the determination of whether to increase or decrease clock speeds when accessing respective ones of the NVM 116.

Relocating critical data to faster data storage components may include identifying critical data. The critical data may be identified based on a predicted data need, one or more upcoming data operations, and/or an indication by a user and/or by the host system 102. Once identified, the critical data may be stored in one or more SLC blocks of the NVM 116 to enable faster read operations. Additionally, clock speeds may be increased when reading data from the SLC blocks, e.g., due to lower error rates and to reduce latency compared to reading data from higher level cells (e.g., TLCs).

The register parameters may include a programming step time and/or a programming step size. For example, a default programing step time may be one hundred (100) microseconds. To speed up operations, the step time may be reduced by a certain percentage, such as by twenty percent (20%), thirty percent (30%), forty percent (40%), fifty percent (50%), or more. The step size may refer to stepping up read voltage during a read operation. For example, a default programming step size may be 0.4 V. To increase speed, the programming step size may be increased to 0.6V, 0.7V, or greater. Adjusting the register parameters may additionally enable faster clock frequencies to be used due to reduced latency associated with read and/or programming operations.

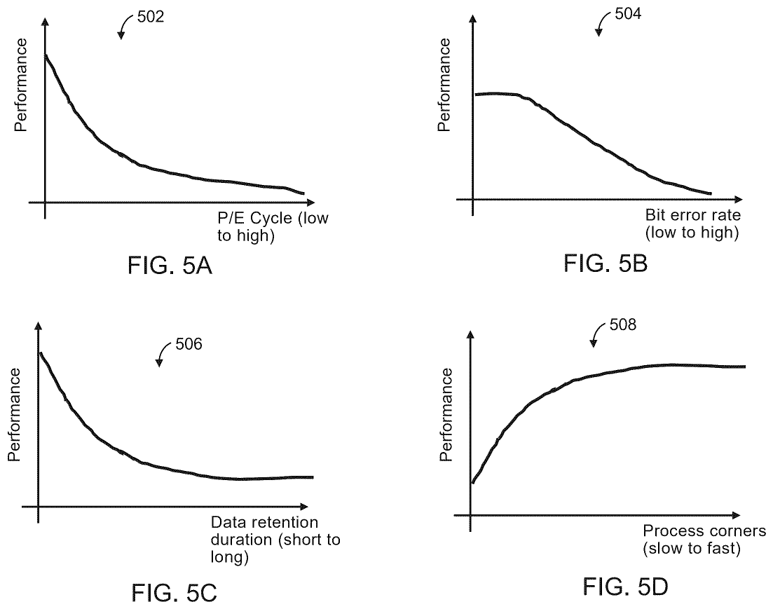

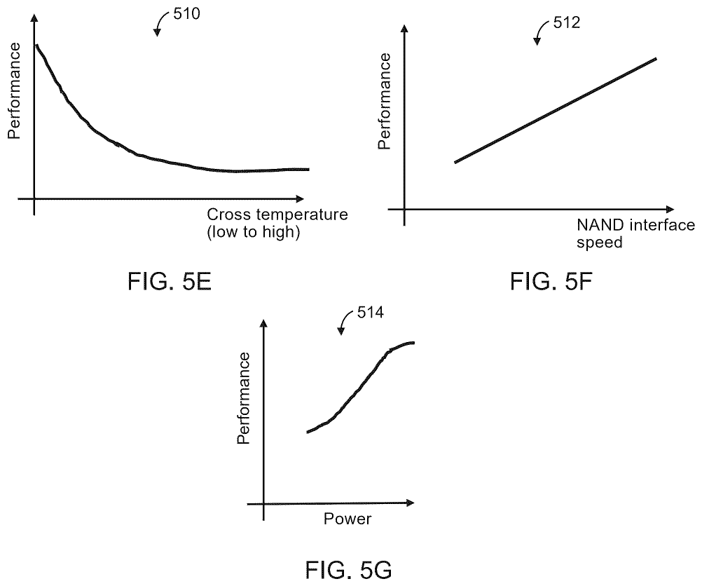

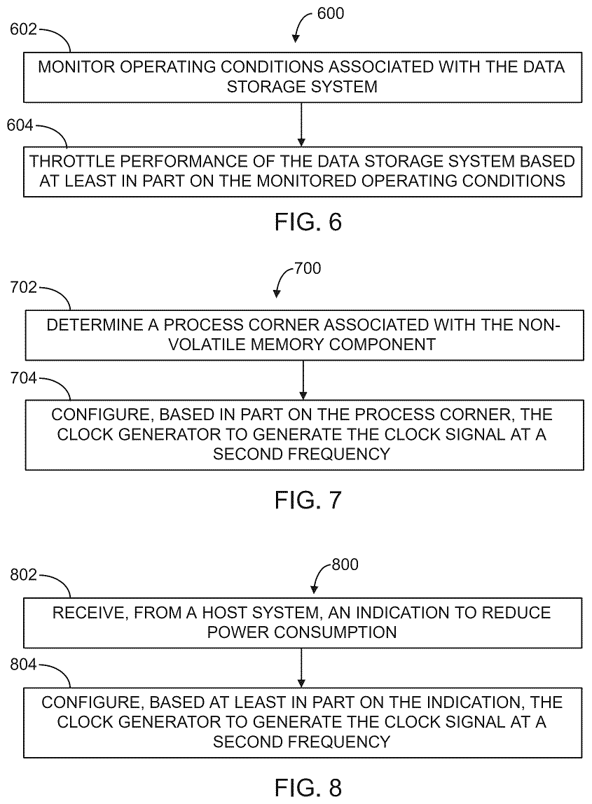

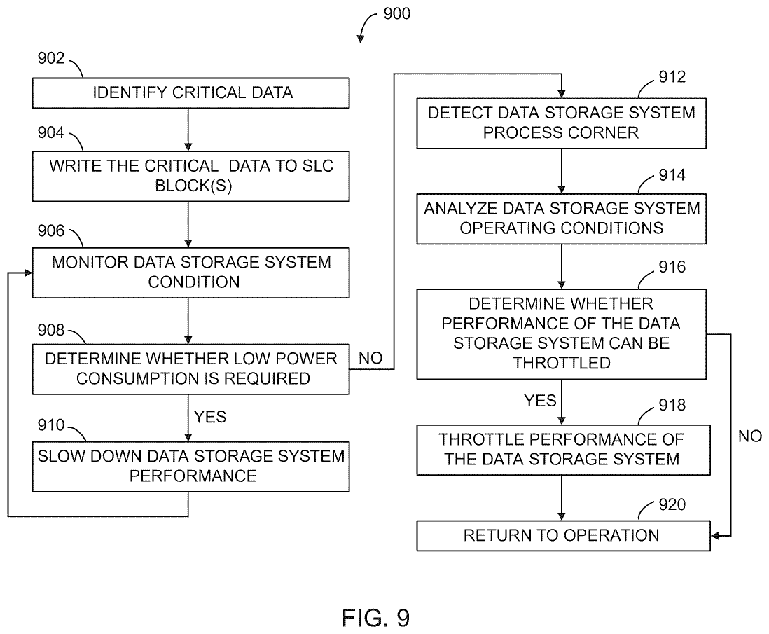

Additional operations and details associated with throttling performance of a data storage system are described in greater detail below in connection with the method 600 of FIG. 6, the method 700 of FIG. 7, the method 800 of FIG. 8, and the method 900 of FIG. 9. In various examples, the processor(s) 103, the processor(s) 108, and/or the performance throttling component 112 may perform any and/or all operations described below with reference to FIGS. 6-9.

In various examples, instructions for executing the performance throttling component 112 may be stored in the local memory 105, the local memory 110, and/or the NVM 116. Some or all functions of the performance throttling component 112 may be executed by the processor(s) 108, the local controller(s) 118, other circuitry of the controller 106 and/or the data storage component 114, and/or a combination thereof.

Through hardware, software, firmware, or various combinations thereof, any of the processing elements (e.g., the controller 106 and/or local controller(s) 118 of FIG. 1B and/or the processing element 202 of FIG. 2) may-alone or in combination with other processing elements—be configured to perform the operations of examples of the present disclosure. The examples described herein in connection with the attached drawing figures are intended to describe aspects of the disclosure in sufficient detail to enable those skilled in the art to practice the disclosure. Other examples can be utilized and changes can be made without departing from the scope of the present disclosure. The system may include additional, less, or alternate functionality and/or device(s), including those discussed elsewhere herein. The above and below detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

FIG. 6 illustrates an example method 600 for throttling performance of a data storage system (e.g., the data storage system(s) 104 of FIGS. 1A and 1B) based on operating conditions. FIG. 7 illustrates an example method 700 for throttling performance of the data storage system based on process corners. FIG. 8 illustrates an example method 800 for throttling performance of the data storage system based on power utilization. FIG. 9 illustrates an example method 900 for throttling performance of the data storage system.

Each of the method 600, the method 700, the method 800, and the method 900 may be performed by a controller (e.g., the controller 106 and/or the performance throttling component 112 of FIG. 1B) of the data storage system and/or by a host system (e.g., the host system 102 of FIG. 1B). The data storage system may include a non-volatile memory storing user data. The data storage system may include one or more clock generators configured to generate one or more clock signals. The clock signal(s) may be provided to various components of the controller and/or the non-volatile memory. The clock signal(s) may be provided at a same frequency or varying frequencies, for example where the frequencies vary between components of the controller and/or the non-volatile memory according to the type of component, differences in performance profiles of impacted areas of memory, and/or other factors. The clock generator(s) may generate the clock signal(s) at one or more first frequencies. The first frequencies may be default ones determined by a manufacturer or adjusted ones determined based on previous performance throttling operation(s).

In various examples, the operations of the method 600 may be performed in connection with the method 700, the method 800, and/or the method 900. The operations of the method 700 may be performed in connection with the method 600, the method 800, and/or the method 900. The operations of the method 800 may be performed in connection with the method 600, the method 700, and/or the method 900. The operations of the method 900 may be performed in connection with the method 600, the method 700, and/or the method 800.

Turning to FIG. 6, at operation 602, operating conditions associated with the data storage system are monitored. The operating conditions may include any of the operating conditions described above. A performance profile for the data storage system may be generated, also as described above. The operating conditions may be embodied in one or more performance profiles. In various examples, operating conditions are monitored and/or performance profiles are generated for several components of the data storage system.

At operation 604, performance of the data storage system is throttled based at least in part on the monitored operating conditions. Throttling performance of the data storage system may include increasing or decreasing one or more operating speed(s) of the data storage system or components thereof depending on the monitored operating conditions and/or the performance profile(s). An operating speed may be increased or decreased in one or more of the manner(s) described in more detail above.

For example, if the monitored operating conditions and/or the performance profile for the data storage system or component thereof indicate(s) that the operating conditions are unfavorable for increasing the operating speed (e.g., high P/E cycle count, high BER, slow process corner, etc.), the operating speed(s) may remain unchanged or be reduced. Reducing the operating speed(s) due to unfavorable conditions may reduce error rates, reduce power consumption, and extend a lifetime of the data storage system.

In another example, if the monitored operating conditions and/or the performance profile(s) indicate(s) that the operating conditions are favorable for increasing the operating speed (e.g., low P/E cycle count, low BER, fast process corner, etc.), the operating speed(s) may be in-creased.

Where multiple frequencies corresponding to multiple components of the data storage system are independently adjustable, it is foreseen that such independent adjustments may be of different degrees, and may comprise simultaneous increases and decreases, within the scope of various examples.

Turning to FIG. 7, at operation 702, a process corner associated with the non-volatile memory component is detected. Process corners are described in more detail above, e.g., in connection with FIG. 1 and FIG. 5D.

At operation 704, the clock generator is configured to generate the clock signal(s) at a second frequency based in part on the process corner. In various examples, the process corner may indicate that the data storage system or component thereof is relatively fast (e.g., compared to other data storage systems or components). Accordingly, the second frequency of the clock signal(s) may be greater than the first clock frequency, thereby increasing an operating speed of the data storage system. The second frequency may be, for example, five percent (5%), ten percent (10%), or more than ten percent (10%) greater than the first frequency.

In various examples, the process corner may indicate that the data storage system is relatively slow (e.g., compared to other data storage systems). Accordingly, the second frequency may be lower than the first frequency, thereby decreasing the operating speed of the data storage system to compensate for the relatively slow process corner.

In various examples, the operating speed may be further adjusted based on monitored operating conditions, as described in more detail above and below. In various examples, multiple clock signals are maintained and are independently adjustable for corresponding components of the data storage system.

Turning to FIG. 8, at operation 802, an indication to reduce power consumption is received from the host system. In various examples, the indication may include a request for the data storage system to enter a low power mode or may comprise data and/or commands the data storage system may analyze or otherwise recognize as indicative of a need for lower power consumption.

At operation 804, the clock is configured to generate the clock signal(s) at a second frequency based on the indication to reduce power consumption. The second frequency may be lower than the first frequency. In various examples, the second frequency may be, for example, fifty percent (50%) or less than fifty percent (50%) lower than the first clock frequency. In various examples, multiple clock signal(s) may be adjusted to the same or varying degrees based on the indication to reduce power consumption.

In various examples, one or more of the reduced frequencies of the clock signal(s) may be held persistently over time, and may comprise a low power mode. Where the host and/or data storage system manage clock signal settings by collective groupings or ranges, for example, the low power mode may be selectively entered and exited (relative to, for example, a default power mode).

In various examples, an indication to exit the low power mode may be received from the host system. Responsive to receiving the indication to exit the low power mode, the clock generator(s) may be configured to generate the clock signal(s) at the first frequency or a third frequency greater than the first and/or second frequency. The clock generator(s) may be configured to generate the clock signal at the third frequency when operating conditions of the data storage system are favorable for increased operating speeds.

Turning to FIG. 9, it should be noted initially that although operations are discussed below at a “data storage system” level of abstraction, more granular components of the system may be managed with the method 900 without departing from the spirit of the present examples, in accordance with the examples provided above. Similarly, the method 900 may be independently applied to multiple such components and/or data storage systems, including using multiple independently-varying or variable clock signals, within the scope of the present examples.

At operation 902, critical data is identified. The critical data may include user data indicated by the host system as critical and/or user data identified by the data storage system as critical (e.g., based on a frequency of access). Non-volatile memory may include a plurality of SLC blocks and a plurality of higher level cell blocks (e.g., MLC, TLC, QLC, and/or PLC blocks). The critical data may be stored in one or more of the higher level blocks.

At operation 904, the critical data is written to one or more SLC blocks. The SLC block(s) may enable faster read operations than the higher level block due to a lower number of read operations performed to extract the user data.

At operation 906, operating conditions of the data storage system are continuously monitored. The operating conditions may include any of the operating conditions described in more detail above.

At operation 908, a determination is made of whether low power consumption is required. In various examples, the host system may send a low power request to the data storage system. The low power request may include an instruction to reduce power consumption. Additional details and alternatives are discussed in more detail above.

At operation 910, if the determination at operation 908 is favorable, performance of the data storage system is slowed down to reduce power consumption, as described in connection with FIG. 1 and the method 800 of FIG. 8.

At operation 912, a process corner of the data storage system is detected or accessed. In various examples, the operation 912 is contingent on the determination at operation 908 being that power consumption reduction is not required. The non-volatile memory component may store one time programming (OTP) bits including process corner information. The process corner information may be stored in the OTP bits during a fabrication process in which the process corner information is determined. The process corner may be detected by issuing a readID command to the data storage component to read the OTP bits containing the process corner information. The readID command may be issued by either the data storage system or the host system.

At operation 914, the operating conditions of the data storage system are analyzed. The operating conditions may include any of the operating conditions described in more detail above or similar conditions, e.g., those discussed in connection with FIG. 1 and FIGS. 5A-5G. Analyzing the operating conditions may include generating a performance profile, again as described in more detail above.

At operation 916, a determination is made of whether the performance of the data storage system can be throttled to increase the operating speed of the data storage system. If the performance throttling cannot be performed to increase the operating speed, the method 900 returns via operation 920 to operation 906. If the operating speed can be increased, the method 900 proceeds to operation 918.

At operation 918, the performance of the data storage system is throttled to increase the operating speed of the data storage system. Throttling the performance may include increasing an operating speed of the data storage system based on the operating conditions and/or the performance profile. Additional details associated with throttling performance are described in more detail in preceding sections above.

### Feature Combinations

According to various examples of the present disclosure, a data storage system may comprise at least one processor and computer-readable media including a non-volatile memory component. The computer-readable media may store instructions that, when executed by the at least one processor, cause the at least one processor to: monitor operating conditions associated with the data storage system; and throttle performance of the data storage system based at least in part on the monitored operating conditions. The throttling performance may include one or more of: adjusting a frequency of a clock signal, relocating critical data within the non-volatile memory component, or adjusting one or more parameters of the non-volatile memory component.

According to various examples of the present disclosure, a data storage system may comprise a clock generator configured to generate a clock signal at a first frequency, at least one processor and computer-readable media including a non-volatile memory component. The computer-readable media may store instructions that, when executed by the at least one processor, cause the at least one processor to: determine a process corner associated with the non-volatile memory component; and configure, based in part on the process corner, the clock generator to generate the clock signal at a second frequency. The second frequency may be greater than the first frequency.

According to various examples of the present disclosure, a data storage system may comprise a clock generator configured to generate a clock signal at a first frequency, at least one processor and computer-readable media including a non-volatile memory component. The computer-readable media may store instructions that, when executed by the at least one processor, cause the at least one processor to: receive, from a host system, an indication to reduce power consumption; and configure, based at least in part on the indication, the clock generator to generate the clock signal at a second frequency. The second frequency may be lower than the first frequency.

In combination with any of the previous examples, throttling performance may include adjusting a frequency of a clock signal.

In combination with any of the previous examples, adjusting a frequency of a clock signal may include increasing the frequency of the clock signal.

In combination with any of the previous examples, a data storage system may include an interface connecting at least one processor and a non-volatile memory component. A clock signal may be one of a first clock signal provided to the at least one processor or a second clock signal provided to the interface.

In combination with any of the previous examples, operating conditions may include a process corner associated with a non-volatile memory component. Instructions, when executed by at least one processor, may cause the at least one processor to: determine, based at least in part on the process corner, to adjust of a frequency of a clock signal. The adjustment may comprise increasing the frequency of the clock signal.

In combination with any of the previous examples, adjusting a frequency of a clock signal may include decreasing the frequency of the clock signal.

In combination with any of the previous examples, operating conditions may include power consumption of a data storage system. Instructions, when executed by at least one processor, may cause the at least one processor to: determine to reduce power consumption; and reduce a frequency of a clock signal based at least in part on the determination to reduce the power consumption.

In combination with any of the previous examples, a determination to reduce power consumption may be responsive to a low power request received from a host system.

In combination with any of the previous examples, throttling performance may include relocating critical data within a non-volatile memory component. The non-volatile memory component may include a plurality of SLC blocks and a plurality of higher level cell blocks. Instructions, when executed by at least one processor, may cause the at least one processor to: determine that the critical data is stored in a higher level cell block of the plurality of higher level cell blocks; and determine, based at least in part on the determination of storage in the higher level cell block, to perform the relocation of the critical data. The relocation may include moving the critical data to an SLC block of the plurality of SLC blocks.

In combination with any of the previous examples, throttling performance may include adjusting parameters of a non-volatile memory component. The parameters may include one or more of: a programming step size or a programming step time.

In combination with any of the previous examples, adjusting parameters may include increasing a programming step size.

In combination with any of the previous examples, adjusting parameters may include decreasing a programming step time.

In combination with any of the previous examples, operating conditions may include one or more of: a number of P/E cycles, a BER, a cross temperature condition, a data retention duration, a process corner, an interface speed, or power consumption.

In combination with any of the previous examples, instructions, when executed by at least one processor, may cause the at least one processor to: monitor operating conditions associated with a data storage system; and throttle performance of the data storage system based at least in part on the monitored operating conditions. The throttling performance may include one or more of: adjusting a second frequency of a clock signal, relocating critical data within a non-volatile memory component, or adjusting one or more parameters of the non-volatile memory component.

In combination with any of the previous examples, throttling performance may include adjusting a second frequency of a clock signal to a third frequency greater than the second frequency.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code em-bodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A data storage system comprising:
at least one processor; and
computer-readable media including a non-volatile memory component, the computer-readable media storing instructions that, when executed by the at least one processor, cause the at least one processor to:
monitor operating conditions associated with the data storage system; and
throttle performance of the data storage system based at least in part on the monitored operating conditions, the throttling performance including one or more of: adjusting a frequency of a clock signal, relocating critical data within the non-volatile memory component, or adjusting one or more parameters of the non-volatile memory component.

2. The data storage system of claim 1, the throttling performance including the adjusting of the frequency of the clock signal.

3. The data storage system of claim 2, wherein the adjusting of the frequency of the clock signal includes increasing the frequency of the clock signal.

4. The data storage system of claim 2, the data storage system including an interface connecting the at least one processor and the non-volatile memory component, wherein the clock signal is one of a first clock signal provided to the at least one processor or a second clock signal provided to the interface.

5. The data storage system of claim 2, the operating conditions including a process corner associated with the non-volatile memory component, wherein the instructions, when executed by the at least one processor, cause the at least one processor to:
determine, based at least in part on the process corner, to perform the adjusting of the frequency of the clock signal, the adjustment comprising increasing the frequency of the clock signal.

6. The data storage system of claim 2, wherein the adjusting of the frequency of the clock signal includes decreasing the frequency of the clock signal.

7. The data storage system of claim 6, the operating conditions including power consumption of the data storage system, wherein the instructions, when executed by the at least one processor, cause the at least one processor to:
determine to reduce power consumption; and
reduce the frequency of the clock signal based at least in part on the determination to reduce the power consumption.

8. The data storage system of claim 7, the determination to reduce the power consumption being responsive to a low power request received from a host system.

9. The data storage system of claim 1, the throttling performance including the relocating of the critical data within the non-volatile memory component, the non-volatile memory component including a plurality of single level cell (SLC) blocks and a plurality of higher level cell blocks, wherein the instructions, when executed by the at least one processor, cause the at least one processor to:
determine that the critical data is stored in a higher level cell block of the plurality of higher level cell blocks; and
determine, based at least in part on the determination of storage in the higher level cell block, to perform the relocation of the critical data, the relocation including moving the critical data to an SLC block of the plurality of SLC blocks.

10. The data storage system of claim 1, the throttling performance including the adjusting of the parameters of the non-volatile memory component, the parameters including one or more of: a programming step size or a programming step time.

11. The data storage system of claim 10, the adjusting of the parameters including increasing the programming step size.

12. The data storage system of claim 10, the adjusting of the parameters including decreasing the programming step time.

13. The data storage system of claim 1,
the operating conditions including one or more of: a number of program/erase (P/E) cycles, a bit error rate (BER), a cross temperature condition, a data retention duration, a process corner, an interface speed, or power consumption.

14. A data storage system comprising:
a clock generator configured to generate a clock signal at a first frequency;
at least one processor; and
computer-readable media including a non-volatile memory component, the computer-readable media storing instructions that, when executed by the at least one processor, cause the at least one processor to:
determine a process corner associated with the non-volatile memory component; and
configure, based in part on the process corner, the clock generator to generate the clock signal at a second frequency, the second frequency being greater than the first frequency.

15. The data storage system of claim 14,
wherein the instructions, when executed by the at least one processor, cause the at least one processor to:
monitor operating conditions associated with the data storage system; and
throttle performance of the data storage system based at least in part on the monitored operating conditions, the throttling performance including one or more of: adjusting the second frequency of the clock signal, relocating critical data within the non-volatile memory component, or adjusting one or more parameters of the non-volatile memory component.

16. The data storage system of claim 15, the throttling performance including the adjusting of the second frequency of the clock signal to a third frequency greater than the second frequency.

17. The data storage system of claim 15, the operating conditions including one or more of: a number of program/erase (P/E) cycles, a bit error rate (BER), a cross temperature condition, a data retention duration, a process corner, an interface speed, or power consumption.

18. A data storage system comprising:
a clock generator configured to generate a clock signal at a first frequency;
at least one processor; and
computer-readable media including a non-volatile memory component, the computer-readable media storing instructions that, when executed by the at least one processor, cause the at least one processor to:
receive, from a host system, an indication to reduce power consumption; and
configure, based at least in part on the indication, the clock generator to generate the clock signal at a second frequency, the second frequency being lower than the first frequency.

19. The data storage system of claim 18,
wherein the instructions, when executed by the at least one processor, cause the at least one processor to:
monitor operating conditions associated with the data storage system; and
throttle performance of the data storage system based at least in part on the monitored operating conditions, the throttling performance including one or more of: adjusting the second frequency of the clock signal, relocating critical data within the non-volatile memory component, or adjusting one or more parameters of the non-volatile memory component.

20. The data storage system of claim 19,
the operating conditions including one or more of: a number of program/erase (P/E) cycles, a bit error rate (BER), a cross temperature condition, a data retention duration, a process corner, an interface speed, or power consumption.
